(19) United States
(12) Patent Application Publication
(10) Pub. No.: US 2015/0302302 A1
(43) Pub. Date: Oct. 22, 2015

(54) METHOD AND DEVICE FOR PREDICTING NUMBER OF SUICIDES USING SOCIAL INFORMATION

(71) Applicant: Hannam-dong, Yongsan-gu Seoul (KR)

(72) Inventors: Doh Kwan Kim, Seoul (KR); Jong Won Kim, Seoul (KR); Woo Jae Myung, Incheon (KR); Hong Hee Won, Seoul (KR); Gil Young Song, Gyeonggi-do (KR); Won Hee Lee, Seoul (KR)

(21) Appl. No.: 14/423,580

(22) PCT Filed: Jun. 18, 2013
(86) PCT No.: PCT/KR2013/005370

§ 371 Date: Feb. 24, 2015

(30) Foreign Application Priority Data
Aug. 24, 2012 (KR) 1020120093069

(51) Int. Cl. G06N 5/04

(52) U.S. Cl. CPC G06N 5/04

(57) ABSTRACT

The present invention discloses a method for predicting the number of suicides using social information by considering more realistic factors such as the current environment where the individuals are frequently exposed to the social atmosphere and interact with each other with the development of the social media as well as the climate and economic conditions affecting suicides, modeling the regression analysis model by reflecting the social information such as the number of suicide-related postings posted in the social network services, the situation in which the suicide of the specific famous person is reported, and the like, and applying the social indicators such as the posting indicator, the specific person's suicide indicator, and the like to the regression analysis model to predict the number of suicides, and a device using the same.

### BACKGROUND OF THE INVENTION

(a) Field of the Invention

The present invention relates to a method of predicting the number of suicides using social information and a device using the same, and more particularly, to a method of predicting the number of suicides using social information in consideration of the current environment where individuals are frequently exposed to social atmosphere and interact with each other as well as climate and economic conditions affecting suicides and a device using the same.

(b) Description of the Related Art

Currently, Korea's suicide rate is estimated to be the highest among the OECD countries.

According to a recent study, suicide is ranked next to cancer, cerebrovascular disease, heart disease as leading causes of deaths in Korea, and has been steadily increasing for the past few years.

Thus, in related areas, increase in a suicide rate in this country is recognized as a serious social problem, and therefore, efforts have been made to predict the suicide rate.

However, in current studies for predicting suicide, only simple and fragmentary factors such as unemployment, temperature, and the like are considered. Consequently there are limitations in predicting reliable results.

Thus, in the present invention, realistic factors affecting suicide are considered to propose a scheme of predicting highly reliable suicide rate. The above information disclosed in this Background section is only for enhancement of understanding of the background of the invention and therefore it may contain information that does not form the prior art that is already known in this country to a person of ordinary skill in the art.

### SUMMARY OF THE INVENTION

### Technical Object

The present invention has been made by considering the aforementioned situation, so the objective of the present invention is to propose a scheme of taking more realistic factors into account to predict a highly reliable suicide rate in consideration of the current environment where individuals are frequently exposed to social atmosphere and interact with each other with development of the social media as well as climate and economic conditions affecting suicides.

### Technical Problem to be Solved

To achieve the aforementioned objective, a method of predicting the number of suicides using social information according to a first aspect of the present invention includes: modeling a regression analysis model for predicting the number of suicides according to variables based on at least one piece of social information collected from a mass media service; setting the variables prior to a specific time; and predicting the number of suicides at the specific time according to variations of the variables by applying the variables set in the setting of the variables to the regression analysis model.

Preferably, the social information may include at least either one of information about the number of postings posted in a specific social network service of the mass media service to indicate the number of postings including a specific dangerous word and information about a specific person's suicide exposed to the mass media service.

Preferably, in the setting of the variable, a posting indicator according to the information about the number of postings collected for the specific collecting period prior to the specific time may be set as the variable.

Preferably, in the setting of the variables, the information about the specific person's suicide for at least some of the specific time may be searched among the collected information about the specific person's suicides within a specific application period after it is first exposed to the mass media service, and the searched specific person's suicide indicator associated with the information about the specific person's suicide may be set as the variable.

Preferably, in the setting of the variable, the variable may be set by applying a weight value according to at least one of the number of exposures of the information about the specific person's suicide by the mass media service, an exposure period by the mass media service, and a difference in the number of days between the time when it is first exposed to the mass media service and the specific time to the specific person's suicide indicator.

Preferably, in the modeling, a regression analysis model for predicting the number of suicides according to the variable based on the at least one piece of social information, climate information including at least one of temperature information, humidity information, and sunshine information, and economic information including at least one of consumption pattern analysis information, consumer price index (CPI) information, unemployment information, and composite stock price index information may be used.

Preferably, the setting of the variables may further set a climate indicator based on the climate information including at least one of temperature information, humidity information, and sunshine information collected for the specific collecting period prior to the specific time and an economic indicator based on the economic information including at least one of consumption pattern analysis information, consumer price index (CPI) information, unemployment information, and composite stock price index as the variable.

To achieve the aforementioned objective, a device for predicting the number of suicides using social information according to a second aspect of the present invention includes: a modeling unit for modeling a regression analysis model for predicting the number of suicides according to a variable based on at least one piece of social information collected from a mass media service; a variable-setting unit for setting the variable prior to a specific time; a prediction controller for applying the predetermined variable to the regression analysis model to predicting the number of suicides at the specific time according to variations of the variable.

### Advantageous Effect

Accordingly, according to the method of the present invention for predicting the number of suicides using the social information and the device using the same, the highly reliable suicide rate can be predicted by considering more realistic factors such as the current environment where the individuals are frequently exposed to the social atmosphere and interact with each other with the development of the social media as well as the climate and economic conditions affecting suicides.

### BRIEF DESCRIPTION OF THE DRAWINGS

FIG. 1 is a block diagram of a device for predicting the number of suicides using social information according to an exemplary embodiment of the present invention.

FIG. 2 is a flowchart for illustrating a method of predicting the number of suicides using the social information according to the exemplary embodiment of the present invention.

FIG. 3 exemplarily illustrates variables applicable to predict the number of suicides at the specific time (t) according to the exemplary embodiment of the present invention

### DETAILED DESCRIPTION OF THE EMBODIMENTS

An exemplary embodiment of the present invention will now be described with reference to the attached drawings.

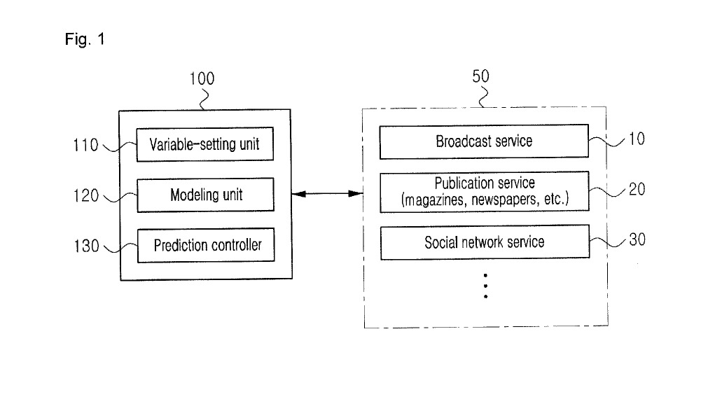

FIG. 1 is a block diagram of a device for predicting the number of suicides using social information according to an exemplary embodiment of the present invention.

As shown in FIG. 1, the device for predicting the number of suicides using the social information according to the exemplary embodiment of the present invention includes a modeling unit 120 for modeling a regression analysis model for predicting the number of suicides according to a variable based on at least one piece of social information collected from a mass media service 50, a variable-setting unit 110 for setting the variable prior to a specific time, and a prediction controller 130 for predicting the number of suicides at the specific time according to variations of the variable by applying the variable set in the variable-setting unit 110 to the regression analysis model.

In this case, the mass media service 50 may include a broadcast service 10 for providing a radio or TV broadcast program through a wire or wireless link, a publication service 20 for providing publications such as magazines and newspapers, a social network service 30 for allowing social networks (such as blogs, Facebook, etc.) to be usable in a wired or wireless internet-accessible environment.

The modeling unit 120 models a regression analysis model for predicting the number of suicides according to the variable based on at least one piece of social information collected from the mass media service 50.

For this purpose, the variable-setting unit 110 may collect at least one piece of social information from the aforementioned mass media service 50.

Alternatively, the modeling unit 120 may collect at least one piece of social information from the aforementioned mass media service 50.

For example, the variable-setting unit 110 may collect at least one piece of social information in collaboration with the mass media service 50, or may be provided with at least one piece of social information from a separate device for collecting at least one piece of social information (not shown) in collaboration with the mass media service 50.

In the present invention, the variable is set based on the social information because a recent increase in the suicide rate in our country is associated with an environment in which, among cultural phenomenon taking place in our country, social media is widely used.

That is, the increase in the suicide rate may be primarily due to the fact that individuals are more frequently exposed to social atmosphere and interact with each other with development of the social media, as well as changes taking place in our country (e.g., economic and climate condition), so social information is used to effectively and precisely predict the number of suicides.

In this case, the social information may include at least either one of information about the number of postings posted in a specific social network service 30 of the mass media service 50 to indicate inclusion of a specific dangerous word and information about specific person′ suicide exposed to the mass media service 50.

In this case, being exposed to the mass media service 50 means being transferred to the general public in the form of broadcasting, printing/publication, posting as news pages via specific media is defined to belong to the mass media service 50 such as broadcasting, magazines, newspapers, Internet news, etc.

In this case, the specific dangerous word may predetermined by an operator, and may be classified into a high-risk word directly indicating a suicide risk such as “suicide”, “want to die”, or the like. or a low-risk word indirectly indicating the suicide risk such as “difficult”, “difficult to live”, or the like.

Thus, the variable-setting unit 110 may collect the information about the number of postings (e.g., blogs, comments, wall posts, etc.), which are posted in the specific social network service 30 of the mass media service 50 to indicate inclusion of the specific risk word, as the social information for a specific collecting period.

More specifically, a method of collecting the information about the number of postings as the social information will be described. After all web pages including the aforementioned specific dangerous word from the postings posted in the specific social network service 30 are searched, the postings (e.g., blogs, comments, wall posts, etc.) posted by the individual users may be filtered according to information about how the searched web pages are constructed, such that the number of filtered postings (e.g., blogs, comments, wall posts, etc.) can be counted and collected.

The information about the specific person's suicide may include at least one of personal information about the specific persons (e.g., age, popularity, and sex), causes of suicides reported by the mass media service 50, a time when it is first exposed to the mass media service 50, the number of exposures to the mass media service 50, and a period of exposure to the mass media service 50.

More specifically, a first method of collecting the information about the specific person's suicide as the social information will now be described. When a report for the specific person's suicide is exposed to the mass media service 50, a suicide report of the corresponding specific person is defined as a celebrity suicide to be collected only when exposed to the mass media service 50 for more than a minimum exposure period (e.g., two weeks), and the corresponding information about the specific person's suicide may be collected.

Meanwhile, a second method of collecting the information about the specific person's suicide as the social information will be described. When the report for the specific person's suicide is exposed to the mass media service 50, only if web content associated with the corresponding specific person's suicide is searched more than a specific limited number of times (e.g., 100 times) within a specific limited period (e.g., one week) that is predefined by the mass media service 50, particularly, the social network service 30, it can be defined as the celebrity suicide to be collected and the corresponding information about the specific person's suicide can be collected.

Alternatively, when both requirements of the first and second methods for collecting the information about the specific person's suicide as the aforementioned social information are satisfied, it can be defined as the celebrity suicide to be collected, and the corresponding information about the specific person's suicide can be collected.

Accordingly, the variable-setting unit 110 may collect the information about the specific person's suicide exposed to the mass media service 50 as the social information.

In addition, the variable-setting unit 110 may set variables based on the social information as described above.

More specifically, the variable-setting unit 110 sets a posting indicator associated with the information about the number of postings collected and a specific person's suicide indicator associated with the information about the specific person's suicide as the variables.

Further, the variable-setting unit 110 may set a climate indicator based on climate information including at least one of temperature information, humidity information, and sunshine information and an economic indicator based on economic information including at least one of consumption pattern analysis information, consumer price index (CPI) information, unemployment information, and composite stock price index information as the variables.

Accordingly, the modeling unit 120 models a regression analysis model for predicting the number of suicides (target variable) according to the variables based on the variables set by the aforementioned variable-setting unit 110 (e.g., the posting indicator, the specific person's suicide indicator, the climate indicator, and the economic indicator) and the information obtained by monitoring the number of actual suicide occurrence.

The regression analysis model may be modeled by the modeling unit 120 from any one of a mathematical model, a statistical model, a combined model of the mathematical model and the statistical model, and may be any one of models using at least one of multiple regression analysis, principal component regression (PCR) analysis, partial least squares regression (PLSR) analysis, neural network-partial least squares regression (PLSR) analysis, kernel-partial least squares regression (PLSR) analysis, and least square support vector machine (LS-SVM) methods.

In addition, the variable-setting unit 120 of the present invention sets the variable for predicting the number of suicides prior to the specific time.

That is, the variable-setting unit 120 may set the variable prior to the specific time (t) for predicting the number of suicides at the specific time (t) such that the variable is transmitted to the prediction controller 130.

More specifically, the variable-setting unit 120 sets at least one of the posting indicator associated with the information about the number of postings collected for the specific collecting period prior to the specific time (t) during which the number of suicides needs to be predicted and the specific person's suicide indicator associated with the information about the specific person's suicide for at least some of the specific time (t) within a specific application period after the time when it is first exposed to the mass media service 50 as the variable

For example, if the specific time (t) during which the number of suicides needs to be predicted is set to every three days, the variable-setting unit 120 may obtain the posting indicator, which is associated with the information about the number of postings collected prior to the specific time (t) during which the number of suicides needs to be predicted, specifically, during the previous specific collecting period (e.g., t-1), as a social indicator, and the posting indicator can be set as the variable.

In addition, the variable-setting unit 120 searches the information about the specific person's suicides for at least some of the specific time (t) of three days during which the number of suicides needs to be predicted, that is, three entire days, two days, or one day within the specific application period (e.g., 30 days) after the time when it is first exposed to the mass media service 50 from the information about the specific person's suicide that are collected, and may obtain the searched specific person's suicide indicator associated with the information about the specific person's suicide as the social indicator.

This is due to the fact that, in order for the specific person's the suicide to affect prediction of the number of suicides at the specific time (t), it should be at least fall within the specific application period (e.g., 30 days).

In this case, after searching the information about the specific person's suicide for at least some of the specific time (t) of three days during which the number of suicides needs to be predicted, the variable-setting unit 120 may not set the specific person's suicide indicator as the social indicator, which is the variable, if the corresponding information about the specific person's suicide does not exist.

More specifically, as described above, the variable-setting unit 120 may apply a weight value according to at least one of the specific person's suicide indicator obtained as the social indicator, the number of exposures of the corresponding information about the specific person's suicide to the mass media service 50, the period of exposure to the mass media service 50, and a difference in the number of days between the time when it is first exposed to the mass media service 50 and the specific time (t) during which the number of suicides needs to be predicted.

That is, the variable-setting unit 120 may predefine a weight value table with which different weight values are applied to each exposure of the specific person's suicide to the mass media service 50, each period of exposure to the mass media service 50, and each difference in the number of days between the time when it is first exposed to the mass media service 50 and the specific time (t) during which the number of suicides needs to be predicted.

For example, as the information about the specific person's suicide is more frequently exposed to the mass media service 50, the exposure period by the mass media service 50 further increases, and the differences in the number of days between the time when it is first exposed to the mass media service 50 and the specific time (t) during which the number of suicides are small so that they are close to each other, the larger weight values of the weight value table can be defined and applied.

Accordingly, the variable-setting unit 120 may check the corresponding weight values based on the aforementioned weight value table, in accordance with the time of exposure of the corresponding information about the specific person's suicide to the mass media service 50 and the difference in the number of days between the time when it is first exposed to the mass media service 50 and the specific time (t) during which the number of suicides needs to be predicted, and may apply the checked weight value to the specific person's suicide indicator obtained as described above.

Accordingly, the variable-setting unit 120 may obtain the specific person's suicide indicator to which the weight value is applied as the social indicator, and may set the specific person's suicide indicator as the variable. In addition, the variable-setting unit 120 may further set a climate indicator based on climate information including at least one of temperature information, humidity information, and sunshine information that are collected for the specific collecting period prior to the specific time (t) during which the number of suicides needs to be predicted, specifically, for the previous specific collecting period (e.g., t-1) and an economic indicator based on economic information including at least one of consumption pattern analysis information, consumer price index (CPI) information, unemployment information, and composite stock price index information collected for the specific collecting period prior to the specific time (t) (e.g., t-1) as the variables.

Accordingly, the prediction controller 130 may apply the variables set in the variable-setting unit 120, that is, the aforementioned posting indicator, the specific person's suicide indicator, the climate indicator, and the economic indicator to the regression analysis model, and may predict the number of suicides at the specific time (t) according to the variables that are applied via the regression analysis model.

Accordingly, in FIG. 3, an example of the variables applied to predict the number of suicides at the specific time (t) is illustrated.

That is, price_yr_1m, unemployment, and stock in FIG. 3 represent the economic indicator that can be applied as the variables, temperature represents the climate indicator that can be applied as the variable, celebrity represents the specific person's suicide indicator that can be applied as the variable, and suicidal (e.g., high-risk word) and emotional (e.g., low-risk word) weblog counts represent the posting indicator that can be applied as the variables.

Accordingly, the prediction controller 130 may apply the aforementioned posting indicator, specific person's suicide indicator, climate indicator, and economic indicator as the variables, select the significant variables at a significance level (p) of less than 5%, and predicting the number of suicides at the specific time (t) according to the variables selected by the regression analysis model, such that a target variable (the number of suicides) can be predicted using the regression analysis model according to a predetermined prediction algorithm.

In this case, the prediction controller 130 may adopt a specific prediction algorithm, in which each of the variables is applied to the modeled regression analysis model to predict the target variable, from existing algorithms, so a detailed description thereof will be omitted.

As described above, according to the device for predicting the number of suicides using the social information according to the exemplary embodiment of the present invention, the highly reliable suicide rate can be predicted by considering more realistic factors such as the current environment where the individuals are frequently exposed to the social atmosphere and interact with each other with the development of the social media as well as the climate and economic conditions affecting suicides, modeling the regression analysis model by reflecting the social information such as the number of suicide-related postings posted in the social network services, the situation in which the suicide of the specific famous person is reported, and the like, and applying the social indicators such as the posting indicator, the specific person's suicide indicator, and the like to the regression analysis model to predict the number of suicides.

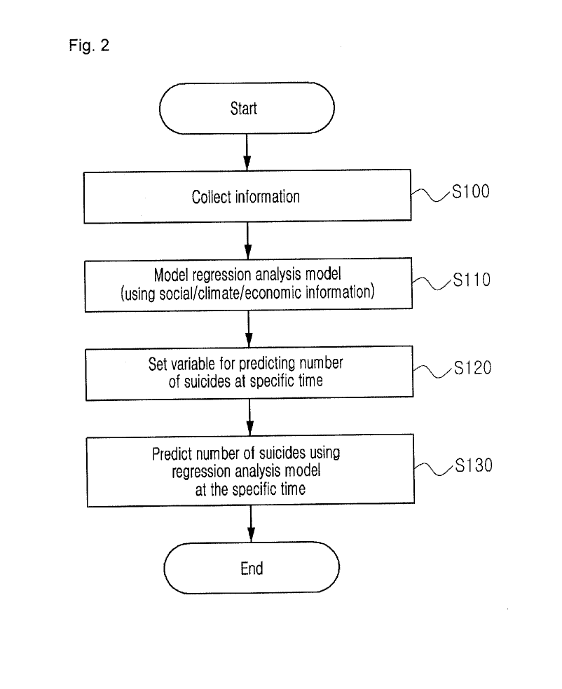

A method of predicting the number of suicides using social information according to an exemplary embodiment of the present invention will now be described with reference to FIG. 2.

For ease of description, the description will be made using the aforementioned reference numerals in the corresponding configuration of FIG. 1 described above.

The method of predicting the number of suicides using the social information according to the exemplary embodiment of the present invention may collect at least one piece of social information via a mass media service 50.

For example, the method of predicting the number of suicides using the social information according to the exemplary embodiment of the present invention may collect at least one piece of social information in collaboration with the mass media service 50, or may be provided with at least one piece of social information from an additional device (not shown) for collecting at least one piece of social information in collaboration with the mass media service 50 (S100).

In this case, the social information may include at least either one of information about the number of postings posted in a specific social network service 30 of the mass media service 50 to indicate inclusion of a specific dangerous word and information about specific person′ suicide exposed to the mass media service 50.

In this case, the specific dangerous word may predetermined by an operator, and may be classified into a high-risk word directly indicating a suicide risk such as “suicide”, “want to die”, or the like. or a low-risk word indirectly indicating the suicide risk such as “difficult”, “difficult to live”, or the like.

Accordingly, the method of predicting the number of suicides using the social information according to the exemplary embodiment of the present invention may collect the information about the number of postings (e.g., blogs, comments, wall posts, etc.), which are posted in the specific social network service 30 of the mass media service 50 to indicate inclusion of the specific risk word, as the social information for a specific collecting period.

More specifically, a method of collecting the information about the number of postings as the social information will be described. After all web pages including the aforementioned specific dangerous word from the postings posted in the specific social network service 30 are searched, the postings (e.g., blogs, comments, wall posts, etc.) posted by the individual users may be filtered according to information about how the searched web pages are constructed, such that the number of filtered postings (e.g., blogs, comments, wall posts, etc.) can be counted and collected.

The information about the specific person's suicide may include at least one of personal information about the specific persons (e.g., age, popularity, and sex), causes of suicides reported by the mass media service 50, a time when it is first exposed to the mass media service 50, the number of exposures to the mass media service 50, and a period of exposure to the mass media service 50.

More specifically, a first method of collecting the information about the specific person's suicide as the social information will now be described. When a report for the specific person's suicide is exposed to the mass media service 50, a suicide report of the corresponding specific person is defined as a celebrity suicide to be collected only when exposed to the mass media service 50 for more than a minimum exposure period (e.g., two weeks), and the corresponding information about the specific person's suicide may be collected

Meanwhile, a second method of collecting the information about the specific person's suicide as the social information will be described. When the report for the specific person's suicide is exposed to the mass media service 50, only if web content associated with the corresponding specific person's suicide is searched more than a specific limited number of times (e.g., 100 times) within a specific limited period (e.g., one week) that is predefined by the mass media service 50, particularly, the social network service 30, it can be defined as the celebrity suicide to be collected and the corresponding information about the specific person's suicide can be collected.

Alternatively, when both requirements of the first and second methods for collecting the information about the specific person's suicide as the aforementioned social information are satisfied, it can be defined as the celebrity suicide to be collected, and the corresponding information about the specific person's suicide can be collected.

Accordingly, the method of predicting the number of suicides using the social information according to the exemplary embodiment of the present invention may obtain the information about the specific person's suicide exposed to the mass media service 50 as the social information.

In addition, the method of predicting the number of suicides using the social information according to the exemplary embodiment of the present invention may set variables based on the social information as described above.

More specifically, the method of predicting the number of suicides using the social information according to the exemplary embodiment of the present invention sets a posting indicator associated with the information about the number of postings collected and a specific person's suicide indicator associated with the information about the specific person's suicide as the variables.

In addition, the method of predicting the number of suicides using the social information according to the exemplary embodiment of the present invention may set a climate indicator based on climate information including at least one of temperature information, humidity information, and sunshine information and an economic indicator based on economic information including at least one of consumption pattern analysis information, consumer price index (CPI) information, unemployment information, and composite stock price index information as the variables.

Accordingly, the method of predicting the number of suicides using the social information according to the exemplary embodiment of the present invention models a regression analysis model for predicting the number of suicides (target variable) according to the variables based on the variables set by the aforementioned variable-setting unit 110 (e.g., the posting indicator, the specific person's suicide indicator, the climate indicator, and the economic indicator) and the information obtained by monitoring the number of actual suicide occurrence (S110).

The modeled regression analysis model may be modeled from any one of a mathematical model, a statistical model, a combined model of the mathematical model and the statistical model, and may be any one of models using at least one of multiple regression analysis, principal component regression (PCR) analysis, partial least squares regression (PLSR) analysis, neural network-partial least squares regression (PLSR) analysis, kernel-partial least squares regression (PLSR) analysis, and least square support vector machine (LS-SVM) methods.

In addition, the method of predicting the number of suicides using the social information according to the exemplary embodiment of the present invention sets a variable for predicting the number of suicides prior to the specific time (S120).

That is, the method of predicting the number of suicides using the social information according to the exemplary embodiment of the present invention may set the variable for predicting the number of suicides prior to the specific time (t) to predict the number of suicides at the specific time (t).

More specifically, the method of predicting the number of suicides using the social information according to the exemplary embodiment of the present invention sets at least one of the posting indicator associated with the information about the number of postings collected for the specific collecting period prior to the specific time (t) during which the number of suicides needs to be predicted and the specific person's suicide indicator associated with the information about the specific person's suicide for at least some of the specific time (t) within a specific application period after the time when it is first exposed to the mass media service 50 as the variable.

For example, if the specific time (t) during which the number of suicides needs to be predicted is set to every three days, the method of predicting the number of suicides using the social information according to the exemplary embodiment of the present invention may obtain the posting indicator, which is associated with the information about the number of postings collected prior to the specific time (t) during which the number of suicides needs to be predicted, specifically, during the previous specific collecting period (e.g., t-1), as a social indicator, and the posting indicator can be set as the variable.

In addition, the method of predicting the number of suicides using the social information according to the exemplary embodiment of the present invention searches the information about the specific person's suicides for at least some of the specific time (t) of three days during which the number of suicides needs to be predicted, that is, three entire days, two days, or one day within the specific application period (e.g., 30 days) after the time when it is first exposed to the mass media service 50 from the information about the specific person's suicide that are collected, and may obtain the searched specific person's suicide indicator associated with the information about the specific person's suicide as the social indicator.

This is due to the fact that, in order for the specific person's the suicide to affect prediction of the number of suicides at the specific time (t), it should be at least fall within the specific application period (e.g., 30 days).

More specifically, as described above, the method of predicting the number of suicides using the social information according to the exemplary embodiment of the present invention may apply a weight value according to at least one of the specific person's suicide indicator obtained as the social indicator, the number of exposures of the corresponding information about the specific person's suicide to the mass media service 50, the period of exposure to the mass media service 50, and a difference in the number of days between the time when it is first exposed to the mass media service 50 and the specific time (t) during which the number of suicides needs to be predicted.

That is, the method of predicting the number of suicides using the social information according to the exemplary embodiment of the present invention may predefine a weight value table with which different weight values are applied to each exposure of the specific person's suicide to the mass media service 50, each period of exposure to the mass media service 50, and each difference in the number of days between the time when it is first exposed to the mass media service 50 and the specific time (t) during which the number of suicides needs to be predicted.

For example, as the information about the specific person's suicide is more frequently exposed to the mass media service 50, the exposure period by the mass media service 50 further increases, and the differences in the number of days between the time when it is first exposed to the mass media service 50 and the specific time (t) during which the number of suicides are small so that they are close to each other, the larger weight values of the weight value table can be defined and applied.

Accordingly, the method of predicting the number of suicides using the social information according to the exemplary embodiment of the present invention may check the corresponding weight values based on the aforementioned weight value table, in accordance with the time of exposure of the corresponding information about the specific person's suicide to the mass media service 50 and the difference in the number of days between the time when it is first exposed to the mass media service 50 and the specific time (t) during which the number of suicides needs to be predicted, and may apply the checked weight value to the specific person's suicide indicator obtained as described above.

Accordingly, the method of predicting the number of suicides using the social information according to the exemplary embodiment of the present invention may obtain the specific person's suicide indicator to which the weight value is applied as the social indicator, and may set the specific person's suicide indicator as the variable.

Further, the method of predicting the number of suicides using the social information according to the exemplary embodiment of the present invention may further set, in the step S120, a climate indicator based on climate information including at least one of temperature information, humidity information, and sunshine information that are collected for the specific collecting period prior to the specific time (t) during which the number of suicides needs to be predicted, specifically, for the previous specific collecting period (e.g., t-1) and an economic indicator based on economic information including at least one of consumption pattern analysis information, consumer price index (CPI) information, unemployment information, and composite stock price index information collected for the specific collecting period prior to the specific time (t) (e.g., t-1) as the variables.

Accordingly, the method of predicting the number of suicides using the social information according to the exemplary embodiment of the present invention may apply the variables set in the step S120, that is, the aforementioned posting indicator, the specific person's suicide indicator, the climate indicator, and the economic indicator to the regression analysis model, and may predict the number of suicides at the specific time (t) according to the variables that are applied via the regression analysis model (S130).

As described above, according to the method of predicting the number of suicides using the social information according to the exemplary embodiment of the present invention, the highly reliable suicide rate can be predicted by considering more realistic factors such as the current environment where the individuals are frequently exposed to the social atmosphere and interact with each other with the development of the social media as well as the climate and economic conditions affecting suicides, modeling the regression analysis model by reflecting the social information such as the number of suicide-related postings posted in the social network services, the situation in which the suicide of the specific famous person is reported, and the like, and applying the social indicators such as the posting indicator, the specific person's suicide indicator, and the like to the regression analysis model to predict the number of suicides.

The method of predicting the number of suicides using the social information according to the exemplary embodiment of the present invention and the device using the same may be embodied in the form of program instructions that can be executed by various computing means, and may be recorded on a computer-readable medium.

The computer-readable medium may include each of or a combination of program instructions, data files, data structures, etc.

The program instructions recorded on the medium may be specifically designed or configured for the present invention, or may be disclosed to a person of an ordinary skill in the computer software to be usable thereby.

Examples of computer-readable medium include a hard disk, a floppy disk, and a magnetic media such as a magnetic tape, an optical media such as a CD-ROM and a DVD, a magneto-optical media such as a floptical disk, a hardware device such as ROM, RAM, and a flash memory specifically configured to store and execute the program instructions.

Examples of the program instructions not only include a machine code such as those made by a compiler but a higher level code that can be executed by the computer using an interpreter and the like.

In order to perform operations of the present invention, the aforementioned hardware device may be configured to operate as at least one software module, and vice versa.

While this invention has been described in connection with what is presently considered to be practical exemplary embodiments, it is to be understood that the invention is not limited to the disclosed embodiments, but, on the contrary, variations and modifications are possible by any person skilled in the art to which the present invention belongs without deviating from the sprit and scope of the present invention set forth in claims, and thus are considered to be within the range of claims of the present invention.

1. A method of predicting the number of suicides using social information comprising: modeling a regression analysis model for predicting the number of suicides according to a variable based on at least one piece of social information collected from a mass media service; setting the variable prior to a specific time; and predicting the number of suicides at the specific time according to variations of the variables by applying the variable set in the setting of the variable to the regression analysis model.

2. The method of claim 1, wherein the social information includes at least either one of information about the number of postings including a specific risk word posted in a specific social network service of the mass media service and information about the specific person's suicide exposed to the mass media service.

3. The method of claim 2, wherein the setting of the variable sets a posting indicator according to the information about the number of postings collected for the specific collecting period prior to the specific time as the variable.

4. The method of claim 2, wherein, in the setting of the variables, the information about the specific person's suicide for at least some of the specific time is searched from the collected information about the specific person's suicides within a specific application period after a time when it is first exposed to the mass media service, and a specific person's suicide indicator associated with the information about the searched specific person's suicide is set as the variable.

5. The method of claim 4, wherein, in the setting of the variables, a weight value according to at least one of the number of exposures of the information about the searched specific person's suicide to the mass media service, an exposure period by the mass media service, and a difference in the number of days between the time when it is first exposed to the mass media service and the specific time is applied to the specific person's suicide indicator according to the information about the searched specific person's suicide, and the specific person's suicide indicator to which the weight value is applied is set as the variable.

6. The method of claim 5, wherein, in the setting of the variables, a climate indicator based on climate information including at least one of temperature information, humidity information, and sunshine information that are collected for a specific collecting period prior to the specific time and an economic indicator based on economic information including at least one of consumption pattern analysis information, consumer price index (CPI) information, unemployment information, and composite stock price index information that are collected for the specific collecting period prior to the specific time are further set as the variables.

7. The method of claim 1, wherein the modeling models regression analysis model for predicting the number of suicides according to the variable based on the at least one piece of social information, climate information including at least one of temperature information, humidity information, and sunshine information, and economic information including at least one of consumption pattern analysis information, consumer price index (CPI) information, unemployment information, and composite stock price index information

8. A device for predicting the number of suicides comprising: a modeling unit for modeling a regression analysis model for predicting the number of suicides according to a variable based on at least one piece of social information collected from a mass media service; a variable-setting unit for setting the variable prior to a specific time; and a prediction controller for predicting the number of suicides at the specific time according to variations of the variable by applying the predetermined variable to the regression analysis model.
